(19) United States
(12) Patent Application Publication
(10) Pub. No.: US 2008/0299363 A1
(43) Pub. Date: Dec. 4, 2008

(54) Method for Preparation of a Lithographic Printing Plate and to a Lithographic Printing Plate Produced by the Method

(76) Inventors: Jivan Gulabrai Bhatt, Bangalore (IN); Thyagarajan Anantharaman Iyer, Mambai (IN)

Correspondence Address: BROMBERG & SUNSTEIN LLP, 125 SUMMER STREET, BOSTON, MA, 02110-1618, US

(21) Appl. No.: 12/139,935

(22) Filed: Jun. 16, 2008

Related U.S. Application Data
(63) Continuation-in-part of application No. 10/769,609, filed on Jan. 30, 2004, now Pat. No. 7,399,507.

(30) Foreign Application Priority Data
Feb. 3, 2003 (IN) 141/MUM/2003

(51) Int. Cl. H05H 1/24; B41L 23/00; B32B 5/00

(52) U.S. Cl. 428/211.1; 427/144; 427/569

(57) ABSTRACT

A lithographic printing plate and a method of preparing a lithographic printing plate is described which is suitable for use with inkjet printers for forming images, wherein the inkjet printers use a pigment based ink. A substrate having thickness of 50 to 400 microns is selected from a group of substrates consisting of a polymeric substrate, a paper substrate, a metal substrate, a fabric substrate and a laminate of a combination of the substrates. At least one layer of a hydrophilic lithographic coating is applied on an operative surface of the substrate. The coating is prepared by mixing together at least one hydrophilic binder, at least one cross-linking agent, at least one catalyst, at least one accelerator, at least one inorganic pigment, at least one surfactant and particulate silica having particle size between 1 to 15 microns and pore volume between 0.2 to 1.8 ml/gm. The layer typically has a thickness of at least 5 microns and at least one layer is applied.

This application is a continuation in part of U.S. patent application Ser. No. 10/769,609, filed Jan. 30, 2004, which claims priority from Indian Patent Application 141/MUM/2003, filed Feb. 3, 2003, which is hereby incorporated by reference.

### FIELD OF THE INVENTION

This invention relates to a method for preparation of a lithographic printing plate and to a lithographic printing plate produced by the method. The plate can also be described using the following terms: direct-to-plate inkjet lithographic printing plate, computer-to-plate or CtP inkjet lithographic plate, computer-to-poly or CtPoly inkjet lithographic plate). Further, the expression refers to an element that is imaged using inkjet printers/plotters, typically for use as a printing plate on an offset printing press. In particular, embodiments of this invention relate to a method of preparing a lithographic printing plate for use by means of inkjet imaging on a substrate. In accordance with another aspect of this invention, it further relates to a method for enhancing the print run length (i.e. the number of copies or impressions that can be printed from the imaged plate) of a plate.

### BACKGROUND OF THE INVENTION

Traditional methods of printing include letterpress printing, gravure printing, offset lithographic printing, and screen-printing. In recent times, with computerization and digitalization of graphic design, photography, page compositions and image transfer processes; digital printing has made rapid strides in the developed nations. All printing processes utilize image carriers to print images on substrates such as paper, plastics, metal etc. Various types of flexible metal, plastic or paper printing plates serve as image carriers in the offset printing process.

The method of creating images on the printing plates has been a subject of considerable research spanning over several decades. Technologies have evolved from manual etchings and engravings to photo-mechanical imaging using ultraviolet light to digital imaging using green, blue, red, infrared and violet lasers.

Each printing process has its own typical requirements with regard to the image forming areas of the printing plate. With the gravure process, the image areas are recessed; with letterpress, the image areas are in relief or raised above the non-image or background areas; with screen printing, the image areas are etched out to allow the ink to pass through; offset is the only process where the image and non-image areas are on the same plane or surface.

The offset plate, therefore, requires special manufacturing as well imaging process to impart oleophilic (ink loving) properties to the image areas, which have to be printed, and hydrophilic (water loving) properties to the non-image or non-printing areas. The substrate used for manufacture of offset printing plates consists of metals, aluminum being the most popular, or plastic, polyester being the preferred choice.

Offset printing plates can be grouped into the following categories. First generation offset plates consist of grained and anodized aluminum plates. These require extended plate preparation time and complicated processing steps to be carried out by the end-user: whirled coating of a photo-sensitive layer; exposure through a film negative or positive; acid development; solvent-based etching; stencil removal, desensitization, gumming up, inking up, etc. The total time to process such a plate is approximately 90 minutes and the print results lack sharpness and are inconsistent.

The second generation offset plates, known as pre-sensitized plates, consist of grained and anodized aluminum plates pre-coated with photosensitive diazo or photo-polymer coatings that are either positive working or negative working. Pre-sensitized plates have a shorter processing cycle of approximately 5 to 10 minutes per plate consisting of exposure to ultraviolet light through a film negative or positive, removal of the coating in non-image area using suitable developers in an automatic processor or manually, and wiping the plate surface manually or in an automatic processor with a protective film of gum. These plates are supplied in pre-coated form by the manufacturer and have to be handled extremely carefully during transport, storage and handling by the end user, as they are extremely sensitive to daylight, heat and moisture.

As mentioned, pre-sensitized plates require the use of an intermediate film positive or negative to serve as a mask at the time of exposure. In a positive plate, the film positive blocks the ultraviolet light from exposing the coating in the image areas, whereas it renders the coating in the non-image areas soluble through light reaction and dissolves away during the wet development process. In a negative plate, the film negative allows the light to expose the image areas and renders them insoluble in the developer; therefore, they remain on the plate after wet development while the original unexposed coating is removed from the non-image areas: The time for preparation of the film positive/negative and the costs involved, are the main limitations of the pre-sensitized plate.

A third generation offset plates, known as digital plates, consist of grained and anodized aluminum coated with coatings that are specially formulated to be reactive to different types of lasers. With the advent of digital technology, original pictures and words are now created or converted into digital formats in a computer. These digital images are then transferred from the computer in the desired format and page composition to a laser-imaging device known as the Platesetter or CtP (Computer-to-Plate) Imaging Device. The digital page is then exposed directly on to the digital plate in the Platesetter. The plate is then developed in a processor to remove the non-image areas, followed by application of a protective film of specially formulated gum. The total processing time per plate is similar to pre-sensitized plates, but the time and costs involved for preparation of the intermediate film positive/negatives are eliminated.

Three types of digital offset plates are currently offered:
A. Thermal Plates that are sensitive to heat and imaged using infrared lasers (830 or 1064 nanometers).
B. Silver-sensitized Plates that are exposed using violet (410 nm), or green (YAG 532 nm), or red. (HeNe 670 nm) lasers.
C. Photopolymer plates that are exposed using violet (410 nm) or blue (Argon 488 nm) or green (YAG 532 nm) or red (HeNe 670 nm) lasers.

All the digital plates mentioned above require/very expensive and unwieldy laser Platesetters and involve chemical processing, with some of the chemicals requiring conformity with stringent disposal norms. In addition, the plates are very expensive. Consequently, the advantages of speed and the savings of film intermediates are nullified by the additional costs. Therefore, digital plates have not met with universal acceptability and their use is limited currently to the high-end newspapers and commercial printers where speed is of essence.

To overcome some of the limitations of the above-mentioned varieties of digital plates, the applicant introduced an affordable, simple and safe digital offset plate “NovaDom” polyester laser plate. This plate is made from polyester (polyethylene terephthalate, also known as PET) base and is imaged directly on a toner-based laser printer. It does not require the use of any chemicals for processing after imaging, and can go directly to an offset press for printing approximately 20,000 copies from each side of the plate. Each side of the plate consists of specially coated surface, which is hydrophilic, and yet capable of establishing a durable bond with the toner deposited in the image areas by a laser printer. The image formed by the laser printer toner acts as the oleophillic receiver, and picks up ink on the press for transfer to the offset blanket and then on to the paper or other printing substrate.

The NovaDom polyester laser plate has proven to be one of the most popular digital printing plates for small format single and spot color printing, worldwide. But NovaDom and other brands of polyester laser plates that followed suffer from the limitation inherent in a laser printer namely the maximum plate size that can be accommodated on the current generation of laser printers is A3. The image resolution and registration accuracy is also limited by the capability of the laser engines, thereby rendering this plate unsuitable for high quality four-color process printing.

In recent years, inkjet printers have replaced laser printers as the most popular output device for graphic printing. The advent of these printers has made it possible to output in sizes ranging from A8 up to super-wide format printing. These printers are of low cost and their reliability has improved significantly in recent times. The resolution capabilities have greatly enhanced, e.g. Epson 7600 is capable of delivering resolution of up to 2880 dpi.

Various disclosures—have been made of the use of inkjet systems for creating an image on grained and anodized aluminum printing plates and other hydrophilic lithographic surfaces. All of these methods and claims pertain to use of specific oleophilizing compounds used as the imaging medium in either liquid or semi-solid (wax) form in the printer's ink cartridge, in place of the standard inkjet printing ink.

In one such disclosure, U.S. Pat. No. 5,501,150, a fluid ink and hydrophilic media set containing materials to produce a silver reducible image by inkjet printing, is used to make a metallic silver image. Major disadvantages are the complexity of the imaging fluid and the need to wet process the silver image to make it sufficiently hydrophobic.

In another such disclosure wherein the ink is a solid or phase change type ink as per U.S. Pat. No. 4,833,486 to deposit hot wax on to surface of an offset plate is described. The roundness of the solidified droplet does not have the resolution of the liquid inkjet. U.S. Pat. No. 5,511,477 discloses a method for producing a photo polymeric relief type printing plates using a photo polymeric ink composition suitable for forming a negative or positive image. U.S. Pat. No. 5,312,654 also discloses a method for making lithographic printing plate using photo polymerizable ink composition on a hydrophilized ink composition. The image is sensitized to cure the image by exposure to actinic light. Research disclosure 289118 discloses a method for making printing by means of an inkjet wherein the ink is hydrophobic polymer latex.

One critical aspect of the disclosures mentioned above and other methods published, necessitates the need for specially formulated compounds to serve as imaging inks. None of them claim to work with standard commercially available inkjet printing inks supplied by the manufacturers of inkjet printers. Also, none of them claim original work done to produce a lithographic plate that can be imaged satisfactorily on inkjet printers and other non-impact and mechanical printer using standard commercially available inks. The plate made as per our invention can be imaged on standard inkjet printers using standard inkjet inks as mentioned above. In addition, the plate can also be imaged on other non-impact printers such as laser printer, etc. as well as impact devices such as photocopier, dot-matrix printer, and the like.

Use of specially formulated imaging fluids and compounds referred to in the disclosures mentioned above, create considerable technical and practical usage problems with regard to ink filling in to the cartridge and maintaining the compatibility with the print head required to be used on inkjet printers. Many of the inkjet printers come with proprietary cartridges and proprietary inks, and contain proprietary microchips, which control the level of ink and respond to the print head. The printers are also able to identify whether the cartridge is genuine. It is not feasible to fill specially formulated imaging fluids in these cartridges, as the guarantee on the performance of the printer becomes void if the original cartridge and ink combination not used. Also, there are other potential complications such as to damage to print heads and ink conduit lines. Moreover, cartridges supplied by the proprietary imaging fluid manufacturers filled with their own imaging fluids, cannot be used on printers as they do not contain the printer manufacturer's microchips. What is clearly special about the plate under this invention is that it does not require the use of specially formulated imaging fluids and instead, works with the standard inkjet cartridges and inks supplied by printer manufacturers.

Unlike the plate under this invention, none of the disclosures referred to above claim compatibility with non-impact digital printing devices (e.g. laser printer), nor do they claim compatibility with impact printers (e.g. dot-matrix printer) and manual imaging methods (e.g. calligraphy).

Some patent disclosures mention pre-sensitized metal plates (i.e. metal plates that are grained, anodized and coated with photosensitive coatings) that are imaged on inkjet printers using special inks or fluids. Importantly, this methodology also suffers from the problems referred to above viz. rejection by the inkjet printers of non-proprietary ink-cartridges filled with imaging fluids. Also, none of these Patent disclosures claim compatibility with all types of inkjet printing devices as well as other non-impact printers (such as laser printers) and impact printers (such as dot-matrix printers) and manual imaging (such as calligraphy).

### SUMMARY OF THE INVENTION

This invention overcomes the limitations of NovaDom and other polyester laser plates by providing a method of making a plate that is suitable for imaging on standard large-format inkjet printers using standard inks such as HP 51645A, HP 51640A, and HP 51629A of Hewlett Packard; Epson T5431 Photo Black, Epson T480011 Black; Epson T5437 Light Black; Epson T5432 Cyan, Epson T483011 Cyan; Epson T5434 Yellow, Epson T481011 Yellow, Epson T5435 Light Cyan, Epson T485011 Light Cyan, Epson T5436 Light Magenta, and Epson T484011 Light Magenta. The aforesaid is an illustrative list of inks, not meant to be exhaustive.

This invention also seeks to provide a plate that can be imaged using standard commercially available inks on a range of inkjet printers using piezo, thermal, bubble jet or continuous ink jet technology.

Embodiments of the present invention are compatible with non-impact printers (inkjet as well as laser printers), impact printers (including dot-matrix printers), and manual imaging methods (including calligraphy). Embodiments of this invention are made from a plastic, metal, paper or fabric or a material made from a combination there of, and are compatible with standard inkjet inks and cartridges. Embodiments of the invention also pertain to the development of an ink receptive plate wherein a reverse printing of up to 4 points is possible. Embodiments of the invention, therefore, extend the boundaries of the currently available technology as well as the applicant's own polyester laser plates.

The main feature of this invention is the development of a plate that can be imaged with the recommended standard commercially available inkjet inks on standard commercially available inkjet printers without the need to wet process the plate after imaging, and having the capability to print high-resolution four color process work. This inkjet plate can also be imaged on other non-impact and impact-printing devices such as laser printers, photocopiers, dot matrix printers, and typewriter using oil based ribbons, thermal printers. The quality of the images would depend upon the capability of the imaging device. The print capability of the plate on an offset press would remain more or less unchanged; with the print run length dependent on the imaging device and the press settings. Experiments conducted indicate ‘run length’ varying from 5,000 copies to 20.000 copies using a laser printer or photocopier.

Another special feature is that embodiments can also be imaged using manual methods such as writing on the plate using calligraphic pens and lithographic inks. Hand-written additions, including signatures, etc can also be incorporated using special addition pens filled with oleophilic inks.

Embodiments of the invention also pertain to the development of an ink receptive plate wherein 2% to 98% dots can be effectively reproduced with instant drying, no smudging, no background scumming, dot gain as per industry standards, and print resolutions matching commercial printing requirements. When used with inkjet printers, embodiments use standard inks which result in low costs and easy integration of the plate imaging process into the normal workflow used in offices, print shops, and publishers. Embodiments do not suffer from size limitations of polyester laser plates since inkjet printers are available in large format (width of 60″ and more). Embodiments are capable of very high resolution including stochastic screens (frequency modulated screens) used for reproducing high quality multi-color photo-realistic images.

Another special and useful feature is that the same inkjet printer that is used for imaging a plate can also be used for digital color proofing of a four color print job. This ensures a very close match between the color proof and the final printed result obtainable from the printing plates imaged on the same printer. Large format inkjet printers are used extensively in printing and newspaper establishments for proofing. The plate, in accordance with this invention integrates seamlessly into their current workflow. It is also an object of the present invention to provide a simple and inexpensive method for preparation of a ‘Computer-to-Plate’ printing plate.

An object of the present invention is to provide a method to make plates for use with commercially available inks and development of a plate to suit the commercially available inks for inkjet printing, such as HP 51645A, HP 51640A, and HP 51629A of Hewlett Packard; Epson T5431 Photo Black, Epson T480011 Black, Epson T5437 Light Black, Epson T5432 Cyan, Epson T483011 Cyan, Epson T5434 Yellow, Epson T481011 Yellow, Epson T5435 Light Cyan, Epson T485011 Light Cyan, Epson T5436 Light Magenta, Epson T484011 Light Magenta, and the like. Another object of this invention is to reproduce image imaged through any and all inks which are pigment-based inks in the market and the upgrades.

Another object of this invention is the development of an ink receptive plate, wherein 2% dots can be effectively reproduced. A further object of the invention is the development of an ink receptive plate, wherein a reverse printing of up to 4 points is achieved.

Yet another object of this invention pertains to development of a plate, which can also be imaged through a laser printer for preparation of a lithographic printing plate. The invention provides compatibility to reproduce image imaged through any and all inks, which are pigment-based inks in the market and the upgrades. When used with inkjet printers, this plate offers several unique advantages.

The invention provides compatibility to reproduce image imaged through any and all inks, which are pigment-based inks in the market and, the upgrades. Standard inks can be used. Therefore, costs would be low and the plate imaging process would integrate into the normal workflow used in offices, print shops and publishers.

A further objective is the development of a plate which can be imaged through calligraphy using special inks for preparation of a lithographic printing plate, or via a typewriter with oil based ink ribbons for preparation of lithographic printing plate. According to this invention there is provided a simple and inexpensive method for preparation of a Digital Printing Plate that can be imaged on standard digital printing devices.

According to this invention there is provided a method of preparing a lithographic printing plate for use with inkjet printers for forming images, the inkjet printers using pigment based inks, the method comprising the following steps:
selecting a substrate having thickness of 50 to 400 microns;
forming at least one hydrophilic lithographic coating by mixing together at least one hydrophilic binder, at least one cross-linking agent, at least one catalyst, at least one accelerator, at least one inorganic pigment, at least one surfactant and particulate silica having particle size between 1 to 15 microns and pore volume between 0.2 to 1.8 ml/gm;
applying said coating to an operative surface of said substrate in at least one layer and thickness of at least of 5 microns; and
drying said coated substrate.

Particularly, the substrate is at least one substrate selected from a group of substrates consisting of a polymeric substrate, a paper substrate, a metal substrate, a fabric substrate and a laminate of a combination of the aforesaid substrates. Typically, the substrate is a polymeric substrate. When the substrate is a polymeric substrate an operative surface of the polymeric substrate is treated by at least one process selected from a group of processes consisting of corona treatment, acid treatment and polymer coating treatment.

In case of a polymeric substrate, the substrate is suitably heat treated to have shrinkage in the range of 0.2 to 2% when exposed to heat at 150° C. for 10 min.

Alternatively, the substrate is a metal substrate. When the substrate is a metal substrate the operative surface of the metal substrate is treated by at least one process consisting of degreasing, electro graining, phosphating, anodizing and a combination of the above processes.

Still alternatively, the substrate is a paper substrate. When the substrate is a paper substrate both operative and non-operative surfaces of the paper substrate are treated with polymer coating. Further, the paper substrate is treated on its non-operative surface for water proofing.

In accordance with another aspect of the invention, the substrate is a fabric substrate. When the substrate is a fabric substrate the fabric is at least one fabric selected from a group of fabrics consisting of woven fabric, non-woven fabric, fabric of natural fibers, fabric of synthetic fibers, fabric of combination of natural and synthetic fibers, fibers reinforced with metal fibers, fibers reinforced with glass fibers and fibers reinforced with carbon fibers. When the substrate is a fabric substrate, both operative and non-operative surfaces of fabric substrate are treated with polymer coating. Further, the non-operative surface of a fabric substrate is also treated for water proofing.

Typically, the hydrophilic binder is at least one compound selected from a group of compounds consisting of polyvinyl alcohol, polymer of acryl amide, co-polymer of acryl amide, co-polymer of hydroxyethyl acrylate and methylmethacrylate, co-polymer of hydroxy methylmethacrylate with acrylic acid, maleic anhydride adduct of vinyl methyl ether, polyvinylpyrrolidone, starch, modified starch, gelatin and hydrolyzed gelatin.

Typically, the cross-linking agent is at least one cross-linking agent selected from a group of cross-linking agents consisting of organic dialdehydes, modified urea-formaldehyde, modified melamine-formaldehyde, polyfunctional aziridine and ammonium zirconium carbonate. Typically, the cross linking agents are added to an extend 0.5% to 2% of the binder.

Typically, the accelerator is at least one accelerator selected from a group of accelerators consisting of ammonium chloride, ammonium sulfate, alum, aluminium chloride and aluminium sulfate.

Typically, the pigment used in the coating is a compound selected from naturally available ores such as mica and silicates such as china clay, aluminum silicates, and oxides of silica, titanium, zinc, aluminum and transition metals.

Typically, the ratio of pigment to binder ranges from 60 to 40 to 85 to 15. Typically, the ratio of particulate silica to pigment ranges from 10 to 50%, preferably 15 to 40%.

Typically, the surfactant is at least one surfactant selected from a group of surfactants consisting of ionic surfactant, non-ionic surfactant and combination of ionic and non-ionic surfactants.

Typically, the catalyst is an acid or an acid generating compound. Preferably, the catalyst is at least one compound selected from a group of compounds consisting of a mineral acid, an organic acid and an anhydride of an organic acid.

In accordance with preferred embodiment of the invention, the hydrophilic lithographic coating contains an optional ultra violet absorber.

Preferably, the coating is applied in a plurality of plies.

In accordance with another aspect of the invention there is provided a lithographic printing plate suitable for use with inkjet printers for forming images thereon using pigment based inks, the printing plate comprising:
a substrate having an operative surface and a thickness of 50 to 400 microns; and
at least one cured layer of a hydrophilic lithographic coating applied on said operative surface, said coating obtained by mixing together at least one hydrophilic binder, at least one cross-linking agent, at least one catalyst, at least one accelerator, at least one inorganic pigment, at least one surfactant and particulate silica having particle size between 1 to 15 microns and pore volume between 0.2 to 1.8 ml/gm; said layer having at least one ply and thickness of at least 5 microns.

Typically, the substrate is at least one substrate selected from a group of substrates consisting of a polymeric substrate, a paper substrate, a metal substrate, a fabric substrate and a laminate of a combination of the aforesaid substrates.

Therefore, one method of this invention has the following amongst other steps: Selection of a right substrate for making of the printing plate. Preferably, the substrate is at least one substrate selected from a group of substrates consisting of a polymeric substrate, a paper substrate, a metal substrate, a fabric substrate and a laminate of a combination of the aforesaid substrates. Preferably, the substrate is any natural or synthetic polymeric sheet element material. Preferably, the polymeric substrate material is PET/PET laminate, or mixed polymeric resin. In case of a polymeric substrate, the tensile strength is in the range of 400 to 3000 Kg/cm², the preferred range is between 1600 to 2400 Kg/cm². Preferably, the polymeric substrate is suitably heat treated to have shrinkage in the range of 0.2 to 2.0% when exposed to heat at 150° C. for 10 min; the preferred range being from 0.4 to 0.8% shrinkage. Preferably, the substrate has a nominal thickness in the range of 50 micron to 400 micron, the preferred thickness range being from 75 micron to 250 micron. There is no size restriction for the plate for use as a lithographic printing plate, hence there are no restrictions in terms of the width or length and therefore plates can be made for any wide format printing up to 4 meters in width. The plates can be in sheet form or rolls for imaging on the large format printers of length of up to 100 meters.

In one aspect of the invention the substrate so selected could be a paper or paper laminate or co-extruded substrate of polymeric plastics and paper. When the substrate is a paper substrate both operative and non-operative surfaces of the paper substrate are treated with polymer coating. Further, the paper substrate is treated on its non-operative surface for water proofing.

In accordance with another embodiment of the invention the substrate is a metal substrate. When the substrate is a metal substrate the operative surface of the metal substrate is treated by at least one process consisting of degreasing, electro graining, phosphating, anodizing and combination of the above processes.

In accordance with another embodiment of the invention the substrate is a fabric substrate. When the substrate is a fabric substrate the fabric is at least one fabric selected from a group of fabrics consisting of woven fabric, non-woven fabric, fabric of natural fibers, fabric of synthetic fibers, fabric of combination of natural and synthetic fibers, fibers reinforced with metal fibers, fibers reinforced with glass fibers and fibers reinforced with carbon fibers. When the substrate is a fabric substrate, both operative and non-operative surfaces of fabric substrate are treated with polymer coating. Further, the non-operative surface of a fabric substrate is also treated for water proofing.

The method of preparation of the plate in connection with the embodiment involves treatment of the substrate to alter the surface energy of the substrate to allow better wetting properties and improved bonding of the functional coating. The effectiveness of the plate in terms of resistance to abrasion during printing is critical to the bonding of the lithographic coating. In accordance with one aspect of the invention one mode of preparing the substrate in connection with the embodiment depends on type of substrate. For example in the case of a polymeric substrate the treatment involves a corona treatment, acid treatment and/or polymer coating treatment to improve the surface energy. In the case of acid treatment halogenated aliphatic acid can be used to treat the surface. The process for the same is critical to process temperature used and residence time for treating the surface.

In another mode of treatment in connection with the embodiment of polymeric substrates, polymeric resins are used to enhance the bonding features, e.g. like polyurethane, polyester resin, polymers of vinyl acetate, co-polymers of acrylates and substituted acrylates wherein the substituted alkyl groups could be a methyl, propyl, and butyl and the like. Co-polymers of hydroxyl substituted acrylates, and methacrylates and the like. In another embodiment of treatment of the substrate in connection with the invention, chlorinated phenols are used to treat the surface.

A main feature of the process of an embodiment of the invention is that the effectiveness of the plate in terms of resistance to abrasion during printing is critical to the bonding of the lithographic coating. The lithographic coating in connection with the embodiment is hydrophilic and is achieved by at least a single ply and preferably two-plies of coating on the treated substrate.

Typically, a particularly suitable cross-linked hydrophilic layer is obtained from a hydrophilic binder cross linked with a suitable cross linking agents, such as formaldehyde, glyoxal, poly-functional aziridine, ammonium zirconium carbonate, melamine-type cross-linker. The cross linking is accelerated by use of suitable accelerators, such as ammonium chloride, aluminum sulphate, aluminum chloride, ammonium carbonate, sulphonic acids, alkane sulphonic acids, aromatic sulphonic acids. The accelerators allow the cross-linking to be effective for web speed of typically 200 ft/min at a residence time of 30 sec. Linked hydrophilic binders used above also can contain an inorganic pigment that increases the mechanical strength of the ply.

Typically, the pigment used in the coating is a compound selected from naturally available ores such as mica and silicates such as china clay, aluminum silicates, and oxides of silica, titanium, zinc, aluminum and transition metals.

The coating of the layer in a plurality of plies, particularly two-plies allows a unique morphology of the structure and creates nano-channels for the ink to pass. The coating in a plurality of plies, particularly, two-plies in connection with the embodiment allows for unique balancing of the solubility and hydrophilicity of the cross-linked hydrophilic coating.

A particular feature of this invention is the selection of suitable grades of silica where in the pore volumes are in the range of 0.2 ml to 1.8 ml/gm. Unique to this invention is the selection of suitable grades of silica wherein the micron size varies in the range 1 micron up to 15 micron. The selection of the silica determines the rate of drying and resolution of the image on application.

The hydrophilic binders that may be used are co-polymers such as, for e.g. polymers and co-polymers of vinyl alcohol, acryl amide, methylol acryl amide, methacrylic acid, hydroxy ethyl acrylate, hydroxy methyl methacrylate, substituted maleic anhydride co-polymer, maleic anhydride, and vinyl methyl ether co-polymer or a combination thereof, poly-vinyl pyrolidone.

The coating is suitably modified with ionic, non-ionic or mixed ionic and non-ionic surfactants to enhance the image receptivity. The thickness of the coating is in accordance with this embodiment would vary from at least 5 microns in a single ply. A preferred final thickness of the coating is also achieved by giving a coating with thickness of at least 5 microns (e.g., 5 to 15 microns) in a first ply and at least 5 microns (e.g., 5 to 25 microns) in a second ply.

The coating can be daylight processable and the manufacturing operation can be done in daylight. The processing of the plate can also be done in daylight. The coating used allows the formation of an image through an ink jet printer having standard cartridges mentioned above to accept ink during an offset process. The formulation allows ink to be dried within 5 min depending on the coverage of the same. Embodiments allow reproduction of image imaged through conventional screening. Embodiments allow reproduction of imaged through stochastic screening on an ink jet printer. The current capabilities of printers available are up to 2880 dpi. Typically, the plate coating was dried in an oven or in a tray at a temperature in the range of 60 to 180° C., preferably between 90 to 150° C.

Embodiments allow clean non-image area free of scum and ensures faster start-up. Dot gain is within industry standards. It is possible to provide four color process capabilities suitable for application in packaging, printing and newspaper application for printing of broadsheets.

### DETAILED DESCRIPTION OF THE INVENTION

The plate of this invention comprises a substrate having an operative surface and a thickness of 50 to 400 microns; and at least one cured layer of a hydrophilic lithographic coating applied on said operative surface, said coating obtained by mixing together at least one hydrophilic binder, at least one cross-linking agent, at least one catalyst, at least one accelerator, at least one inorganic pigment, at least one surfactant and particulate silica having particle size between 1 to 15 microns and pore volume between 0.2 to 1.8 ml/gm; said layer having at least one ply and thickness of at least 5 microns.

The substrate is at least one substrate selected from a group of substrates consisting of a polymeric substrate, a paper substrate, a metal substrate, a fabric substrate and a laminate of a combination of the aforesaid substrates.

Preferably the substrate is any natural or synthetic polymeric sheet element material. Preferably, the polymeric substrate material is PET/PET laminate, or mixed polymeric resin.

In case of a polymeric substrate, the tensile strength in the range of 400 to 3000 Kg/cm²; the preferred range being between 1600 to 2400 Kg/cm². Preferably the polymeric substrate is suitably heat treated to have shrinkage in the range of 0.2 to 2.0% when exposed to heat at 150° C. for 10 min; the preferred range being from 0.4 to 0.8% shrinkage. Preferably the substrate has a nominal thickness in the range of 50 micron to 400 micron, the preferred thickness range being from 75 micron to 250 micron. There is no size restriction for the plate for use as a lithographic printing plate, hence there are no restrictions in terms of the width or length and therefore plates can be made for any wide format printing up to 4 meters in width. The plates can be in sheet form of in rolls for imaging on the large format printers of length of up to 100 meters.

In one aspect of the invention the substrate so selected could be a paper or paper laminate or co-extruded substrate of polymeric plastics and paper. When the substrate is a paper substrate both operative and non-operative surfaces of the paper substrate are treated with polymer coating. Further, the paper substrate is treated on its non-operative surface for water proofing.

In accordance with another embodiment of the invention the substrate is a metal substrate. When the substrate is a metal substrate the operative surface of the metal substrate is treated by at least one process consisting of degreasing, electro graining, phosphating, anodizing and combination of the above processes.

In accordance with another embodiment of the invention the substrate is a fabric substrate. When the substrate is a fabric substrate the fabric is at least one fabric selected from a group of fabrics consisting of woven fabric, non-woven fabric, fabric of natural fibers, fabric of synthetic fibers, fabric of combination of natural and synthetic fibers, fibers reinforced with metal fibers, fibers reinforced with glass fibers and fibers reinforced with carbon fibers. When the substrate is a fabric substrate, both operative and non-operative surfaces of fabric substrate are treated with polymer coating. Further, the non-operative surface of a fabric substrate is also treated for water proofing.

The basic ingredients of the coating are at least one hydrophilic binder, at least one cross-linking agent, at least one catalyst, at least one accelerator, at least one inorganic pigment, at least one surfactant and particulate silica having particle size between 1 to 15 microns and pore volume between 0.2 to 1.8 ml/gm.

The hydrophilic binders are preferably water soluble of water dispersible polymers are preferred for the binding of pigments, good adhesion to the base and improve the hydrophilic property of the coated plate. Water soluble polymers such as polyacrylamide, polyvinyl alcohol, starch, modified starch derivatives etc are examples of binders used for the lithographic plate. One property of such a binder is to provide sites for cross-linking so that the final plate withstands the mechanical stress during the printing operation.

Cross-linking agents are used according to the functionality of the binder used. Melamine formaldehyde, urea formaldehyde, dialdehydes such as glyoxalin, poly aziridine such as Crosslinker 100 (supplied by DSM), zirconium ammonium carbonate, boric acid are some of the Examples used as cross linking agents. Aluminum sulphate is used as an accelerator for the cross linking wherever an aldehyde or an aldehyde derivative is used as cross linking agent.

Catalysts are more preferably organic and inorganic acids whether monobasic or polybasic. Inorganic acids pause the risk of corrosion in cases any unused acid in the film. Organic acids are easy to handle and their use is known to the people in the art.

The accelerators are typically selected from a group of accelerators consisting of ammonium chloride, ammonium sulfate, alum, aluminium chloride and aluminium sulfate.

The pigment is a compound selected from naturally available ores such as mica and silicates such as china clay, aluminum silicates, sodium silicate, and oxides of silica, titanium, zinc, aluminum and transition metals.

The ratio of pigment to binder is important in the plate preparation, too much of binder will improve binding property, but also will reduce the hydrophilic property thereby causing heavy background density on the printed images. Higher percentages of pigments (and fillers also) will create chalking of the coating making it weak in binding and hence the print run length will be affected. A ratio of pigment to binder ranges from 60 to 40 to 85 to 15.

The ratio of particulate silica to pigment should range from 10 to 50%, preferably 15 to 40%. The ratio of particulate silica is critical to the final resolution of the image formed and has an impact on the print resolution. The use of particulate silica is less than 10% of the pigment.

Cross linking agents are added to an extent of 0.5% to 2% of the binder for improved hardness of the plate coating. Higher amount do not affect the plate performance but they are not preferred as the ageing properties of the plate will be affected by such higher amount of the cross linking agents.

A catalyst is added to the coating composition. Typically, the catalyst is an acid or an acid generating compound. Preferably, the catalyst is at least one compound selected from a group of compounds consisting of a mineral acid, an organic acid and an anhydride of an organic acid. Acid catalyst are part of the cross linking process. Acids are directly added or they can be generated during the heating process using derivatives of acids.

In accordance with preferred embodiment of the invention, the hydrophilic lithographic coating contains an optional ultra violet absorber. The use of a UV absorber improve the aesthetics of the image produced and particularly the contrast of images formed on plates in which the composition contains the UV absorber such as UVTEX OB is improved.

Coating thickness of the plate is represented in microns. The higher the coating weight the better is the image resolution but after a limit of 20 grams per square meter, coating above 30 grams per square meter does not add any further advantage to the print property, whereas the coating process will become difficult at high coating thicknesses. Coating of less than 5 micron has an adverse effect on the print property as the ink smudging is seen with currently available inkjet printers, for Example Epson 7600 which is delivering a 3.7 pico-liter minimum drop size.

The coating of the lithographic plate can be done in one ply or in multiple ply layers without affecting the print properties and the binding property provided such coating hardware is available. Coating multiple layers is discussed in the examples but this do not restrict from preparing the plate using a wet on wet multiply coating system using a curtain coater or a slot die coater.

The drying temperature of the plate coating is found to affect the plate properties. Preferred temperature range is between 60° C. and 180° C., most preferably between 90° C. and 150° C. A temperature gradient between the upper and lower limits are used as the most preferred drying and curing process which is known to the people in the art of coating films paper and metal.

The hydrophilic coatings formulated can be coated on a coating machine using any one of the coating methods, selected from:

Meir bar wire coatings

Comma doctor

Three roll reverse

Indirect comma doctor

Gravure coating

Indirect gravure with chamber doctor

The drying and curing of the composition is critical to get a uniform stress free layer with uniform layers.

The specific plate dimensions may vary in different embodiments. For example, the lithographic plate can be imaged through an inkjet printer using a pigment based ink.

In the case of the polymeric substrate Polyester is the preferred substrate materials because of their tensile properties and heat resistance during the processing of the plate, though other polymer films suitable for the requirements of a printing machine can be used for the plate preparation. Metal substrates are the most preferred substrates for lithographic printing. The treatment of the metal is known to the people in the art and the same is used as a base material for an inkjet lithographic plate coating. A resin coated paper which prevents the penetration of water in to the substrate can also be made use of for the preparation of the plate. Fabric substrates can also be used.

Polymeric substrate pre-treatment of the base is known in the coating industry. Acid etching and resin coating after a corona treatment are known processes to the people in the art.

Metal substrates for lithographic coating are treated by methods known to the people in the industry. Minor variations depending on the requirement of coating methods and processing conditions are applied for the performance of the coating.

Paper or fabric can also be used as a printing medium where laser toner is the image forming medium. A resin coated paper can be applied for coating lithographic plates for short run (less than 5,000 impressions) applications where in the paper is pre-coated with a resin that prevents the penetration of water into the paper during the printing process. Acrylic resins, polyurethane dispersions and polyester resins are the type of material commonly used for the paper treatments for such an application.

The invention will now be described with reference to the accompanying non-limiting examples.

### EXAMPLE 1

### Conventional Using Agfa Laser Link Plates

The Laser Link plates manufactured and available in the market from M/s Agfa was used for printing images thereon via an Epson 7600 printer using Epson T5431 Photo Black, Epson T480011 Black and Epson T5437 Light Black inks. The printed images were tested for drying time. Drying took more than 4 hrs. in each of the cases and still the ink when rubbed with the finger, rubbed out. Dots above 30% bled and loosened out on resolution at screen ruling of 100 lines per inch (lpi). Reverse prints bled and were not legible.

### EXAMPLE 2

### Conventional Using Omega EZ

The omega EZ Link plate manufactured and available in the market from M/s Auto type was used for printing images thereon via an Epson 7600 printer using Epson T5431 Photo Black, Epson T5437 Light Black and Epson T480011 Black inks. The printed images were tested for drying time, and it took more than 4 hrs and still the ink when rubbed with the finger rubbed out. Dot gain was found in dots above 70 percent and loose out on resolution at screen ruling of 120 lpi. Reverse prints bled and were not legible.

### EXAMPLE 3

### Conventional Using NovaDom

The Nova Dom laser-printing plate manufactured by the applicant was used for printing images thereon via an Epson 7600 printer using Epson T5431 Photo Black, Epson T5437 Light Black and Epson T480011 Black inks. The printed images were tested for drying time took more than 2 hrs and still the ink when rubbed with the finger rubbed out. Dot gain was found in dots above 70 percent and loose out on resolution at screen ruling of 120 lpi. Reverse prints bled and were not legible.

### EXAMPLE 4

### Example in Accordance with One Specific Embodiment of the Invention

A lithographic printing plate in accordance with this invention was prepared in the following manner. A substrate for making of the printing plate was selected from sheet material of polyester having a tensile strength of 2200 Kgm/cm2 and thickness of 100 microns in a size of 297 mm wide and 420 mm long. The element was heat stabilized at a temperature of 180° C. for a residence time of 2 minutes in a drying tunnel. The shrunk element was treated using an acid treatment of the following composition.

Treating Composition 1

| | |
|---|---|
| Water | 97% |
| Tri-chloro acetic acid | 5% |
| Surfactant | 0.05% |

The surface of the element was treated to heat at 140° C. for 30 sec. and the acid fused to the polyester.

### Lithographic Composition:

Separately a hydrophilic lithographic coating composition was formed by reacting 240 grams of partially hydrolyzed poly vinyl alcohol and blended with 60 grams of poly acryl amide solution in a kettle for two hrs at a temp of 80° C. This blend was used for dispersion of 770 grams of Tio2 and 260 grams of particulate silica of average particle size of 6 microns and a pore volume of 1.2 ml per gm in a kinetic disperser for two hrs. To this was added with 15 grams of a cross linking agent glyoxalin, 8 grams of accelerator ammonium sulphate, 8 grams of catalyst, Para-toluene sulphonic acid and 5 grams of an Ethoxylated nonyl phenol. The coating composition was homogenized in a pearl mill for 6 hours.

The hydrophilic coating composition as described above was coated in two plies using a draw down bar on the treated element. The coating was done to give a ply in the range of 10 microns, in the first ply and 15 microns in the second ply. The plate with the coating thereon was cured in an aerofoil dryer for 1 minute where the temperature was maintained at 150° C. for each of the plies.

Several plates were prepared and used for printing images thereon via an Epson 7600 printer and 9600 using Epson T5431 Photo Black, Epson T5437 Light Black, and Epson T480011 Black inks, and HP printer DeskJet series like HP 850, HP 880, HP 690, And HP DesignJet series like HP 250f0, HP 3500, HP 430, HP 755, HP 5000, HP 5500 using HP 51645A, HP 51640A and HP 51629A inks.

In respect of each of the images, the ink dried on the respective plates within 5 minutes and a sharp image was formed thereon. The image in each case was fixed to the plate by curing at 140° C. in an oven for 3 minutes. The results obtained thereon was tested for print run length and printed up to 10000 impressions. Coating resistance to abrasion was satisfactory for 10000 prints run. Resolution as determined by dot gain at 100 lpi in 2 to 100% range, was within industry acceptable tolerances. Resolution as determined by sharpness of reverse print up to 4 points size was clear and sharp.

### EXAMPLE 5

### EXAMPLE IN ACCORDANCE WITH ANOTHER EMBODIMENT

A lithographic printing plate in accordance with this invention was prepared in the following manner. A substrate for making of the printing plate was selected from sheet material of polyester having a tensile strength of 2200 Kgm/cm² and thickness of 100 microns in a size of 297 mm wide and 420 mm long. The element was heat stabilized at a temperature of 180° C. for a residence time of 2 minutes in a drying tunnel. The shrunk element was treated using an acid treatment of the following composition.

Treating Composition II

| | |
|---|---|
| Water | 95% |
| Trichloro acetic acid | 4% |
| Surfactant (ethoxylated nonyl phenols) | 0.05% |
| Silica | 3% |

The treated surface of the element was further subjected to heat at 140° C. for 30 sec. and the acid fixed to the polyester. The addition of silica increased the surface area and provided with silanol groups for bonding of subsequent layer with hydrogen bonding.

### Lithographic Composition:

Separately a hydrophilic lithographic coating was formed by reacting 240 grams of partially hydrolyzed poly vinyl alcohol and blended with 60 grams of poly acryl amide solution in a kettle for two hrs at a temp of 80° C. This blend was used for dispersion of 770 grams of Tio2 and 260 grams of particulate silica of a pore volume of 1.2 ml per gm in a kinetic disperser for 2 hrs. To this was added with 15 grams of a cross-linking agent glyoxalin, 8 grams of accelerator like ammonium sulphate, 8 grams of catalyst like para toluene sulphonic acid and 5 grams of an ethoxylated nonyl phenol surfactant. The coating composition was homogenized in a pearl mill for 6 hours.

The hydrophilic coating composition as described above was coated in two plies using a draw down bar on the treated element. The coating was done to give a ply of 10 microns in the first ply and 15 microns in the second ply. The plate with the coating thereon was cured in an aerofoil dryer for 1 minute where the temperature was maintained at 150° C. for each of the plies.

Several plates were prepared and used for printing images thereon via an Epson 7600 printer and 9600 using Epson T5431 Photo Black, Epson T5437 Light Black, and Epson T480011 Black inks, and HP printer DeskJet series like HP 850, HP 880, HP 690; and HP DesignJet series like HP 2500, HP 3500, HP 430, HP 755, HP 5000, HP 5500 using HP 51645A, HP 51640A and HP 51629A inks.

The ink dried on the plate within 5 minutes and a sharp image was formed thereon in each case. The image was fixed to the plate by curing at 140° C. in an oven for 3 minutes. The results obtained thereon were tested for print run length of 10,000 impressions. The coating and image remained intact. The coating withstood 10,000 prints run and therefore exhibited resistance to abrasion.

The same lithographic plate as described in the above experiment was tested for print length without fixing the plate and was found to give run lengths of up to 2000 impressions. The coating remained intact. Resolution as determined by dot gain at 100 lpi in 2 to 100% range was within industry acceptable tolerances. Resolution as determined by sharpness of reverse print up to 4 points size, was clear and sharp.

### EXAMPLE 6

A lithographic printing plate in accordance with this invention was prepared in the following manner. A PET substrate was selected. The PET substrate was then subjected to corona discharge. This corona discharged surface was treated by following composition to obtain a surface dynes level of 45 dynes/cm.

| | |
|---|---|
| Co-polymer of polyester resin | 15% |
| 99% Hydrolyzed PvOH | 10% |

Acrylic emulsion of ethyl acrylate

| | |
|---|---|
| Butyl acrylate | 10% |
| Water | 50% |

The lithographic composition as described in Example 4 was applied to this element in two-plies of total thickness of 25 microns and a lithographic printing plate was made in the same way.

Several plates were prepared and used for printing images thereon via an Epson 7600 printer and 9600 using Epson T5431 Photo Black, Epson T5437 Light Black, and Epson T480011 Black inks, and HP printer DeskJet series like HP 850, HP 880, HP 690, and HP DesignJet series like HP 2500, HP 3500, HP 430, HP 755, HP 5000, HP 5500 using HP 51645A, HP 51640A and HP 51629A inks.

The ink dried on the plate within 5 minutes and a sharp image was formed thereon in each case. The image was fixed to the plate by curing at 140° C. in an oven for 3 minutes. The results obtained thereon were tested for print run length and even after 10,000 impressions, the image remaining intact. The coating withstood 10,000 prints run and remained intact. The coating therefore showed resistance to abrasion.

The same lithographic plate as described in the above experiment was tested for print length without fixing the plate and was found to give run lengths of up to 2000 impressions. The coating remained intact. Resolution as determined by dot gain at 100 lpi in 2 to 100% range was within industry acceptable tolerances. Resolution as determined by sharpness of reverse print up to 6 points size was clear and sharp.

### EXAMPLE 7

A lithographic printing plate in accordance with this invention was prepared in the following manner. The same composition as per Example 4 was prepared with the exception that the particulate silica used was of a lower pore volume of 0.2 mm/gm in the lithographic composition.

Several plates were prepared and used for printing images thereon via an Epson 7600 printer and 9600 using Epson T5431 Photo Black, Epson T5437 Light Black, and Epson T480011 Black inks, and HP printer DeskJet series like HP 850, HP 880, HP 690, and HP DesignJet series like HP 2500, HP 3500, HP 430, HP 755, HP 5000, HP 5500 using HP 51645A, HP 51640A and HP 51629A inks.

The ink dried on the plate after 30 minutes and image was smudged and had dot gain. The image was fixed to the plate by curing at 140° C. in an oven for 3 minutes. The results obtained thereon were tested for print run length and even after 10,000 impressions the image remained intact. The coating withstood 10,000 prints run and remained intact. Resolution as determined by dot gain at 100 lpi in 2 to 100% range, was not acceptable. This shows that for preparation of a lithographic plate for use with Ink Jet application, the pore volume of silica used in lithographic composition has significant impact on the print resolution.

### EXAMPLE 8

A lithographic printing plate in accordance with this invention was prepared in the following manner. The same composition as per Example 6 was prepared with the exception that the lithographic composition was applied in a single ply of a thickness of 4 microns on to the treated support as explained in Example 6.

Several plates were prepared and used for printing images thereon via an Epson 7600 printer and 9600 using Epson T5431 Photo Black, Epson T5437 Black, and Epson T480011 Black inks, and HP printer DeskJet series like HP 850, HP 880, HP 690, and HP DesignJet series like HP 2500, HP 3500, HP 430, HP 755, HP 5000, HP 5500 using HP 51645A, HP 51640A and HP 51629A inks.

The ink did not dry on the plate with any of the inks and the image was poor in resolution. The plate was mounted on an AB Dick printer and printed 2000 copies. The coating withstood for 2000 copies. The image quality was not acceptable to the standards.

### EXAMPLE 9

A lithographic printing plate in accordance with this invention was prepared in the following manner. The treating method is same as in Example 6. Separately a hydrophilic lithographic coating composition was formed by reacting grams of 240 grams of fully hydrolyzed poly vinyl alcohol and blended with 60 grams of poly acryl amide solution in a kettle for 2 hrs at a temp of 80° C. This blend was used for dispersion of 770 grams of Tio2 and 260 grams of particulate silica of a pore volume of 1.2 ml per gm in a kinetic disperser for 2 hrs. To this were added 15 grams of a cross-linking agent glyoxalin and 5 grams of non ionic surfactant. The coating composition was homogenized in a pearl mill for 6 hours.

An aqueous composition as described above was coated in two plies using a pilot coater with direct comma roll applicator on the treated element. The plate with the coating thereon was cured in an aerofoil dryer for 1 minute and the temperature was maintained at 150° C.

Several plates were prepared and used for printing images thereon via an Epson 7600 printer and 9600 using Epson T5431 Photo Black, Epson T5437 Light Black, and Epson T480011 Black inks, and HP printer DeskJet series like HP 850, HP 880, HP 690, and HP DesignJet series like HP 2500, HP 3500, HP 430, HP 755, HP 5000, HP 5500 using HP 51645A, HP 51640A and HP 51629A inks.

The ink dried on the plate within 5 minutes and a sharp image was formed thereon in each case. The image was fixed to the plate by curing at 140° C. in an oven for 3 minutes. The results obtained thereon were tested for print run length gave a print length of 1000 impressions. Coating hardness to abrasion did not withstand more than 1,000 prints run and the coating weakened thereafter. The addition of acid catalyst is critical to impart coating hardness and has an impact on the print run length.

### EXAMPLE 10

A lithographic printing plate in accordance with this invention was prepared in the following manner. A PET substrate was selected. The PET substrate was then subjected to corona discharge. This corona discharged surface was treated by following composition to obtain a surface dynes level of 45 dynes/cm.

| | |
|---|---|
| Co-polymer of polyester resin | 12-20% |
| 99% Hydrolyzed PvOH | 6-12% |

Acrylic emulsion of ethyl acrylate

| | |
|---|---|
| Butyl acrylate | 35% |
| Water | 67-33% |

### Lithographic Composition:

Separately a hydrophilic lithographic coating was formed by reacting 240 grams of partially hydrolyzed poly vinyl alcohol and blended with 60 grams of poly acryl amide solution in a kettle for two hrs at a temp of 80° C. This blend was used for dispersion of 770 grams of TiO₂ and 70 grams of particulate silica of a pore volume of 0.2 ml per gm in a kinetic disperser for two hrs. To this was added with 15 grams of a cross-linking agent glyoxalin, 8 grams of accelerator ammonium sulphate, 8 grams of catalyst para toluene sulphonic acid and 5 grams of a non-ionic surfactant. The coating composition was homogenized in a pearl mill for 6 hours. An aqueous composition as described above was coated in two plies using a draw down bar on a treated element. The plate with the coating thereon was cured in an aerofoil dryer for 1 minute and the temperature was maintained at 150° C.

The lithographic composition as described above was applied to this element in two-ply and a lithographic printing plate was made in the same way.

Several plates were prepared and used for printing images thereon via an Epson 7600 printer and 9600 using Epson T5431 Photo Black, Epson T5437 Light Black, and Epson T480011 Black inks, and HP printer DeskJet series like HP 850. HP 880, HP 690, and HP DesignJet series like HP 2500, HP 3500, HP 430, HP 755, HP 5000, HP 5500 using HP 51645A, 11P 51640A and HP 51629A inks.

The ink dried on the plate within 5 minutes, however the image formed on the plate was of poor resolution. The image was fixed to the plate by curing at 140° C. in an oven for 3 minutes. The results obtained thereon were tested for print run length and printed up to 10,000 impressions with the image remaining intact. Coating hardness to abrasion withstood 10,000 prints run and the coating remained intact. Resolution as determined by dot gain at 100 lpi in 2 to 100% range, wherein the dot gain obtained was very high in the shadows and not within industry acceptable tolerances. Resolution as determined by sharpness of reverse print was smudged and not clear. It is therefore seen that the ratio of silica used is critical to the final resolution of the image formed and has an impact on the print resolution.

### EXAMPLE 11

A lithographic printing plate in accordance with this invention was prepared in the following manner. The same composition as per Example 6 was prepared with the exception that the subbing layer used for bonding of the lithographic composition was made up of:

| | |
|---|---|
| Co-polymer of polyester resin | 12-20% |
| 99% Hydrolyzed PvOH | 6-12%, |

Acrylic emulsion of ethyl acrylate

| | |
|---|---|
| Butyl acrylate | 15-35% |
| Water | 67-33% |

The subbing solution so formed was coated on to an element exposed to corona discharge to get a surface dynes level of 45 dynes/cm.

### Lithographic Composition:

Separately a hydrophilic lithographic coating was formed by reacting 240 grams of partially hydrolyzed Poly Vinyl alcohol and blended with 60 grams of Poly acryl amide solution in a kettle for two hrs at a temp of 80° C. This blend was used for dispersion of 680 grams of coating grade china clay and 150 grams of particulate silica of a pore volume of 1.2 ml per gm in a kinetic disperser for 8 hrs. To this was added with 15 grams of a cross-linking agent glyoxalin, 8 grams of accelerator ammonium sulphate, 8 grams of catalyst Para toluene sulphonic acid and 5 grams of a non-ionic surfactant. The coating composition was homogenized in a pearl mill for 6 hours. An aqueous composition as described above was coated in two plies using a draw down bar on a treated element. The plate with the coating thereon was cured in an aerofoil dryer for 1 minute and the temperature was maintained at 150° C.

The lithographic composition as described above was applied to this element in two-ply and a lithographic printing plate was made in the same way.

Several plates were prepared and used for printing images thereon via an Epson 7600 printer and 9600 using Epson T5431 Photo Black, Epson T5437 Light Black, and Epson T480011 Black inks, and HP printer DeskJet series like HP 850, HP 880, HP 690, And HP design jet series like HP 2500, HP 3500, HIP 430, HP 755, HP 5000, HP 5500 using HP 51645A, HP 51640A and HP 51629A inks.

The ink dried on the plate within 5 minutes. The image was fixed to the plate by curing at 140° C. in an oven for 3 minutes. The results obtained thereon was tested for print run length and printed up to 10,000 impressions with the image remaining intact. Coating hardness to abrasion withstood 10,000 prints run and the coating remained intact. Resolution as determined by dot gain at 100 lpi in 2 to 100% range, wherein the dot gain obtained was within industry acceptable tolerances. Resolution as determined by sharpness of reverse print up to 4 points size was clear. It is therefore seen that as a pigment coating grade china clay could also be used with similar print performance.

### EXAMPLE 12

The same composition was prepared as that described in Example 4 with the exception that the coated lithographic composition contained 8 grams of methane sulphonic acid. An aqueous composition as described above was coated in two plies using a draw down bar on a treated element.

The coating was done to give a ply of 10 microns in the first ply and 15 microns in the second ply. Each ply of the plate with the coating thereon was cured in an aerofoil dryer for 1 minute and the temperature was maintained at 150° C. for each of the plies.

Several plates were prepared and used for printing images thereon via an Epson 7600 printer and 9600 using Epson T5431 Photo Black, Epson T5437 Light Black, and Epson T480011 Black inks, and HP printer DeskJet series like HP 850, HP 880, HP 690, and HP DesignJet series like HP 2500, HP 3500, HP 430, HP 755, HP 5000, HP 5500 using HP 51645A, HP 51640A and HP 51629A inks. The results obtained were similar to Example 4.

### EXAMPLE 13

The same composition was prepared as that described in Example 4 with the exception that the coated lithographic composition also contained 5 grams of an ultraviolet absorber Uvitex OB. An aqueous composition as described above was coated in two plies using a draw down bar on a treated element. The coating was done to give 10 microns in the first ply and 15 microns in the second ply. The plate with the coating thereon was cured in an aerofoil dryer for 1 minute where the temperature was maintained at 150° C. for each of the plies. When tested for print images as in the above examples the contrast was found to be superior to the plates as prepared in example 4. The aesthetics of image is therefore improved with the use of UV absorber.

### EXAMPLE 14

A lithographic coating composition was prepared as that described in Example 4 with the exception that the coated hydrophilic composition would also contain 60 grams of acid treated aluminum oxide and 200 grams of precipitated silica of pore volume 0.15 ml/gm respectively.

An aqueous composition as described above was coated in two plies using a draw down bar on a treated element. The coating was done as in Example 5. The plate with the coating thereon was cured in an aerofoil dryer for 1 minute and the temperature was maintained at 150° C. for each of the plies.

When tested for images as in the above example, the print run length was below 2000 impressions. The 50% dot area of the test chart had a dot gain of 28% which is above the normal standards. This shows that aluminum oxide or precipitated silica not of low pore volume did not give the desired results anticipated in accordance with this invention.

### EXAMPLE 15

A lithographic composition was prepared as that described in example 4 with the exception that the hydrophilic binder blend used for the lithographic composition contained 60 grams of hydroxyl substituted methyl meth-acrylate co-polymer. An aqueous composition as described above was coated in two plies using a draw down bar on a treated element. The coating and drying was done as in example 5.

Several plates were prepared and used for printing images thereon via an Epson 7600 printer and 9600 using Epson T5431 Photo Black, Epson T5437 Light Black, and Epson T480011 Black inks, and HP printer DeskJet series like HP 850, HP 880, HP 690, and HP DesignJet series like HP 2500, HP 3500, HP 430, HP 755, HP 5000, HP 5500 using HP 51645A, HP 51640A and HP 51629A inks. The results obtained were similar to Example 4.

### EXAMPLE 16

A lithographic composition was prepared as that described in example 4 with the exception that the coated lithographic composition contained 15 grams of methylated urea as a cross-linker in place of glyoxalin. Coating and drying was done in the same manner.

Several plates were prepared and used for printing images thereon via an Epson 7600 printer and 9600 using Epson T5431 Photo Black, Epson T5437 Light Black, and Epson T480011 Black inks, and HP printer DeskJet series like HP 850, HP 880, HP 690, and HP DesignJet series like HP 2500, HP 3500, HP 430, HP 755, HP 5000, HP 5500 using HP 51645A, HP 51640A and HP 51629A inks. The results obtained were similar to Example 4.

### EXAMPLE 17

A lithographic composition was prepared as that described in Example 4 with the exception that the hydrophilic composition would contain 240 gms of partially hydrolyzed poly vinyl alcohol as hydrophilic binder in place of fully hydrolyzed poly vinyl alcohol. An aqueous composition as described above was coated in two plies on n a treated polyester sheet of 75 micron thickness. Coating and drying was done as in the above examples.

Several plates were prepared and used for printing images thereon via an Epson 7600 printer and 9600 using Epson T5431 Photo Black, Epson T5437 Light Black, and Epson T480011 Black inks, and HP printer DeskJet series like HP 850, HP 880, HP 690, and HP DesignJet series like HP 2500, HP 350Q, HP 430, HP 755, HP 5000, HP 5500 using HP 51645A, HP 51640A and HP 51629A inks. The results obtained were similar to Example 4.

### EXAMPLE 18

A lithographic printing plate in accordance with an embodiment of this invention was prepared in the following manner. The same composition as per Example 4 was prepared with the exception that the treating composition used for bonding of the lithographic composition was made up of co-polymer of vinyl acetate and vinyl chloride (Trade Name VMCH) as a 10% solution in methyl ethyl ketone and ethyl acetate. The treating solution so formed was coated on to a 250 micron polyester sheet after exposing to corona discharge. An aqueous lithographic composition similar to Example 4 was coated and dried as described in Example 4.

Several plates were prepared and used for printing images thereon via an Epson 7600 printer and 9600 using Epson T543 1 Photo Black, Epson T5437 Light Black, and Epson T480011 Black inks, and HP printer DeskJet series like HP 850, HP 880, HP 690, and HP design jet series like HP 2500, HP 3500, HP 430, HP 755, HP 5000, HP 5500 using HP 51645A, HP 51640A and HP 51629A inks.

The ink dried on the plate within 5 minutes. The image was fixed to the plate by curing at 140° in an oven for 3 minutes. The results obtained thereon was tested for print run length and printed up to 10,000 impressions with the image remaining intact. Coating hardness to abrasion withstood 10,000 prints run and the coating remained intact. Resolution as determined by dot gain at 100 lpi in 2 to 100% range, wherein the dot gain obtained was within industry acceptable tolerances. Resolution as determined by sharpness of reverse print up to 4 points size, was clear.

### EXAMPLE 19

A lithographic printing plate was made from a high wet strength paper of 120 gram per square meter with a cobb value 20. The paper was coated on both sides with a co-polymer of styrene and acrylates to improve the wet strength. On this was coated the lithographic composition as per Example 4 in two plies to a total thickness of 15 microns and dried as described in Example 4.

Several plates were prepared and used for printing images thereon via an Epson 7600 printer and 9600 using Epson T5431 Photo Black, and HP printer DeskJet series like HP 850, and HP DesignJet series like HP 2500 using pigment based ink.

The ink dried on the plate within 5 minutes. The image was fixed to the plate by curing at 110° C. in an oven for 2 minutes. The results obtained thereon was tested for print run length and printed up to 5,000 impressions with the image remaining intact. Coating hardness to abrasion withstood 5,000 prints run and the coating remained intact. Resolution as determined by dot gain at 100 lpi in 2 to 98% range, wherein the dot gain obtained was within industry acceptable tolerances. Resolution as determined by sharpness of reverse print up to 4 points size, was clear.

### EXAMPLE 20

A lithographic printing plate in accordance with an embodiment of this invention was prepared in the following manner. The hydrophilic coating composition was made by mixing 80 g of titanium dioxide and 30 g of precipitated silica with pore volume 0.8 ml/g together with 400 g distilled water in a kinetic disperser. The resulting slurry was added to 240 g of a 10% aqueous solution of polyvinyl alcohol (Poval 117 from Kuraray). To this was added 60 g of a 10% solution of polyacrylamide and mixed thoroughly. Then 8 g of a solution of 4% glyoxalin and 0.8 g of para-toluene sulphonic acid was added to the mixture, followed by 1 g of a 10% aqueous solution of 9.5 mole ethoxylated nonyl phenol. An accelerator of 0.5 g of aluminum sulphate is added as a 20% solution to the mixture while stirring. The resulting lacquer was further mixed under the kinetic mixture for 30 min and degassed under vacuum.

A polyester film was pretreated as in Example 4, and the treated polyester sheet was then coated with the above composition so as to achieve 30 g coating weight in multiple passes using a wire wound bar. Each layer was dried at temperature higher than 120 degree C. before the next layer. The coated plate was imaged using an Epson 7600 printer using ultra-chrome ink and fused for 1 min at 120° C. and printed using an AB Dick press. 10,000 copies of the image were printed. The results of the plates were as that of plates made as in example 4.

### EXAMPLE 21

A treated film as in Example 5 was coated with the lacquer as prepared in Example 20 using a 1.5 mm wire wound bar so as to get a coating weight of 28 g in a single ply. The coated film was dried at 130° C. The plate was imaged as in Example 20 and printed on an AB Dick press, and 10,000 copies were printed using the plate. The plates show dot loss in lower dot area (less than 10%) otherwise the results were as in example 20.

### EXAMPLE 22

A treated film as in Example 5 was coated with the lacquer as in Example 20 using a 0.4 mm wire in one layer of thickness 4 microns and dried at 130° C. to get a dry coating weight of 5 gram. The plate was imaged using an Epson printer using ultrachrome ink and printed using an AB Dick press. The image on the plate showed smudging of ink and the coating started wearing off after 500 copies.

### EXAMPLE 23

A lithographic coating lacquer was prepared by mixing 80 g of titanium dioxide and 30 g silica pigment with a 1.2 ml/gram pore volume together with 400 g of water and 0.2 g of para-toluene sulphonic acid in a kinetic stirrer. The resulting slurry was added to 150 g of a 10% aqueous solution of polyvinyl alcohol (Poval 117 from Kuraray) and 150 g of solution of a second polyvinyl alcohol (Gohsenol GH23). Then 0.7 gram of a solution of 40% glyoxalin and 0.6 gram of Para-toluene sulphonic acid, followed by 1 gram of a 10% aqueous solution of 9.5 mole ethoxylated nonyl phenol was added to this mixture. An accelerator of 0.5 g of aluminum sulphate was added as a 20% solution to the mixture while stirring. The mixture was further mixed under the kinetic mixture for 30 min and degassed under vacuum. The resulting lacquer was coated on to a pretreated polyester sheet of 175 micron on two plies and dried at 130 degree C. to get a total coating weight of 22 g. The coated plate was imaged using an Epson 7600 printer with ‘ultrachrome’ ink and fused for 1 min at 120° C. An AB Dick press was used to print 10,000 copies of the image. Very sharp images were obtained from the plate as compared to example 20.

### EXAMPLE 24

The plate as prepared in Example 23 was imaged using an HP DesignJet 2500 printer using pigmented ink (supplied as ‘UV ink’ by Hewlett-Packard). The images were printed on an AB Dick press to produce 5,000 copies.

### EXAMPLE 25

The plate as prepared in Example 23 also was imaged using an HP DesignJet 2500 printer using a dye-based ink. The imaged plates were printed on an AB Dick press. No image was printed on the paper.

### EXAMPLE 26

A lithographic plate as in Example 23 was prepared except that a 150 micron degreased, electrograined and anodized aluminum plate is used as the base material. The coated plate was imaged using an Epson 7600 printer using ‘ultrachrome’ ink and fused for 1 min at 120° C. An AB Dick press was used to print 10,000 copies of the image.

### EXAMPLE 27

A lithographic plate was prepared as in Example 23 except that the base material was a both side acrylic resin coated paper of 150 gram per square meter basis weight. The coated plate was imaged using an Epson 7600 printer using ‘ultrachrome’ ink and fused for 1 min at 120° C. An AB Dick press was used to print 2,000 copies.

### EXAMPLE 28

A lithographic plate was prepared as mentioned in Example 20 to get a coating weight of 80 g in multi-ply coating.

The coated plate was imaged on an Epson 7600 printer using ‘ultrachrome’ ink and also on HP 2500C printer using pigmented ink. Imaged plates were fused for 1 min at 120° C. An AB Dick press was used to print 2,000 copies. The images were of poor density and reverse images of 6 point was not resolved.

### EXAMPLE 29

A lithographic printing plate was made as per Example 4, except that the element used for coating was a “Tyvek” sheet. The “Tyvek” sheet was coated with a co-polymer of styrene and acrylates to improve the coating adhesion. A lithographic coating as per Example 4 was coated in two plies to a total thickness of 15 microns and dried as described in Example 4.

Several plates were prepared and used for printing images thereon via an Epson 7600 printer and 9600 using Epson T5431 Photo Black, ink.

The ink dried on the plate within 5 minutes. The image was fixed to the plate by curing at 130° C. in an oven for 1 minute. The plate was tested for a print run length and printed up to 5,000 impressions with the image remaining intact. The coating withstood 5,000 prints run.

### EXAMPLE 30

A lithographic printing plate was made as in Example 4 except that the element used for coating was a closely woven polyester fabric. The polyester fabric sheet was coated with a polyurethane dispersion to impregnate the fabric. On this was coated the lithographic composition as in Example 4 in two plies of total thickness of 15 microns and dried as described in Example 4.

Several plates were prepared and used for printing images thereon via an Epson 7600 printer and 9600 using Epson T5431 Photo Black ink.

The ink dried on the plate within 5 minutes. The image was fixed to the plate by curing at 120° C. in an oven for 2 minutes. The plate was tested for a print run length and printed up to 5,000 impressions with the image remaining intact. The coating withstood 5,000 prints run.

### EXAMPLE 31

A lithographic printing plate was made as per Example 30 except that the polyester fabric was coated with a polyester dispersion to impregnate the mesh and to improve the adhesion. On this was coated the lithographic composition as per Example 30 in two plies of total thickness of 15 microns and dried as described in Example 30.

Several plates were prepared and used for printing images thereon via an Epson 7600 printer and 9600 using Epson T5431 Photo Black ink.

The ink dried on the plate within 5 minutes. The image was fixed to the plate by curing at 120° C. in an oven for 2 minute. The plate was tested for a print run length and printed up to 5,000 impressions with the image remaining intact. The coating withstood 5,000 prints run.

While considerable emphasis has been placed herein on the structures and structural interrelationships between the component parts of the preferred embodiments, it will be appreciated that many embodiments can be made and that many changes can be made in the preferred embodiments without departing from the principals of the invention. These and other changes in the preferred embodiment as well as other embodiments of the invention will be apparent to those skilled in the art from the disclosure herein, whereby it is to be distinctly understood that the foregoing descriptive matter is to be interpreted merely illustrative of the invention and not as a limitation.

What is claimed is:

1. A method of preparing a lithographic printing plate for use with inkjet printers for forming images, the inkjet printers using pigment based inks, the method comprising the following steps:
selecting a substrate having thickness of 50 to 400 microns;
forming at least one hydrophilic lithographic coating by mixing together at least one hydrophilic binder, at least one cross-linking agent, at least one catalyst, at least one accelerator, at least one inorganic pigment, at least one surfactant and particulate silica having particle size between 1 to 15 microns and pore volume between 0.2 to 1.8 ml/gm;
applying said coating to an operative surface of said substrate in at least one layer and thickness at least of 5 microns; and
drying said coated substrate.

2. A method according to claim 1, wherein the substrate is at least one substrate selected from a group of substrates consisting of a polymeric substrate, a paper substrate, a metal substrate, a fabric substrate and a laminate of a combination of the aforesaid substrates.

3. A method according to claim 1, wherein the substrate is a polymeric substrate.

4. A method according to claim 1, wherein the substrate is a polymeric substrate and an operative surface of the polymeric substrate is treated by at least one process selected from a group of processes consisting of corona treatment, acid treatment and polymer coating treatment.

5. A method according to claim 1, wherein the substrate is a polymeric substrate and the substrate is suitably heat treated to have shrinkage in the range of 0.2 to 2% when exposed to heat at 150° C. for 10 min.

6. A method according to claim 1, wherein the substrate is a metal substrate.

7. A method according to claim 1, wherein the substrate is a metal substrate and the operative surface of the metal substrate is treated by at least one process consisting of degreasing, electro graining, phosphating, anodizing and combination of the above processes.

8. A method according to claim 1, wherein the substrate is a paper substrate.

9. A method according to claim 1, wherein the substrate is a paper substrate and both operative and non-operative surfaces of the paper substrate are treated with polymer coating.

10. A method according to claim 1, wherein the substrate is a paper substrate and the non-operative surface is treated for water proofing.

11. A method according to claim 1, wherein the substrate is a fabric substrate.

12. A method according to claim 1, wherein the substrate is a fabric substrate and the fabric is at least one fabric selected from a group of fabrics consisting of woven fabric, non-woven fabric, fabric of natural fibers, fabric of synthetic fibers, fabric of combination of natural and synthetic fibers, fibers reinforced with metal fibers, fibers reinforced with glass fibers and fibers reinforced with carbon fibers.

13. A method according to claim 1, wherein the substrate is a fabric substrate and both operative and non-operative surfaces of fabric substrate are treated with polymer coating.

14. A method according to claim 1, wherein the substrate is a fabric substrate and the non-operative surface is treated for water proofing.

15. A method according to claim 1, wherein the coating is applied on the operative surface of the substrate in a plurality of plies typically two plies.

16. A method according to claim 1, wherein the hydrophilic binder is at least one compound selected from a group of compounds consisting of polyvinyl alcohol, polymer of acryl amide, co-polymer of acryl amide, co-polymer of hydroxyethyl acrylate and methylmethacrylate, co-polymer of hydroxy methylmethacrylate with acrylic acid, maleic anhydride adduct of vinyl methyl ether, polyvinylpyrrolidone, starch, modified starch, gelatin and hydrolyzed gelatin.

17. A method according to claim 1, wherein the cross-linking agent is at least one cross-linking agent selected from a group of cross-linking agents consisting of organic dialdehydes, modified urea-formaldehyde, modified melamine-formaldehyde, polyfunctional aziridine and ammonium zirconium carbonate.

18. A method according to claim 1, wherein the cross linking agents are added to an extent of 0.5% to 2% of the binder.

19. A method according to claim 1, wherein the accelerator is at least one accelerator selected from a group of accelerators consisting of ammonium chloride, ammonium sulfate, alum, aluminium chloride and aluminium sulfate.

20. A method according to claim 1, wherein the pigment used in the coating is a compound selected from naturally available ores such as mica and silicates such as china clay, aluminum silicates, and oxides of silica, titanium, zinc, aluminum and transition metals.

21. A method according to claim 1, wherein the ratio of pigment to binder ranges from 60:40 to 85:15.

22. A method according to claim 1, the ratio of particulate silica to pigment ranges from 10 to 50%, preferably 15 to 40%.

23. A method according to claim 1, wherein the surfactant is at least one surfactant selected from a group of surfactants consisting of ionic surfactant, non-ionic surfactant and combination of ionic and non-ionic surfactants.

24. A method according to claim 1, wherein the catalyst is an acid.

25. A method according to claim 1, wherein the catalyst is an acid generating compound.

26. A method according to claim 1, wherein the catalyst is at least one compound selected from a group of compounds consisting of a mineral acid, an organic acid and an anhydride of an organic acid.

27. A method according to claim 1, wherein the hydrophilic lithographic coating contains a UV absorber.

28. A method according to claim 1, wherein the coating is applied in a plurality of plies.

29. A lithographic printing plate suitable for use with inkjet printers for forming images thereon using pigment based inks, the printing plate comprising:
a substrate having an operative surface and a thickness of 50 to 400 microns; and
at least one cured layer of a hydrophilic lithographic coating applied on said operative surface, said coating obtained by mixing together at least one hydrophilic binder, at least one cross-linking agent, at least one catalyst, at least one accelerator, at least one inorganic pigment, at least one surfactant and particulate silica having particle size between 1 to 15 microns and pore volume between 0.2 to 1.8 ml/gm; said layer having at least one ply and thickness of at least 5 microns.

30. A lithographic printing plate according to claim 29, wherein the substrate is at least one substrate selected from a group of substrates consisting of a polymeric substrate, a paper substrate, a metal substrate, a fabric substrate and a laminate of a combination of the aforesaid substrates.
